(19) United States
(12) Patent Application Publication
(10) Pub. No.: US 2021/0286105 A1
(43) Pub. Date: Sep. 16, 2021

(54) METHODS AND SYSTEMS FOR FACILITATING FORECASTING OF IN-SITU ENVIRONMENTAL CONDITIONS USING NONLINEAR ARTIFICIAL NEURAL NETWORKS-BASED MODELS

(71) Applicant: Carlos F. Gaitan Ospina, San Diego, CA (US)

(72) Inventor: Carlos F. Gaitan Ospina, San Diego, CA (US)

(21) Appl. No.: 17/199,233

(22) Filed: Mar. 11, 2021

Related U.S. Application Data
(60) Provisional application No. 62/988,215, filed on Mar. 11, 2020.

(51) Int. Cl. G01W 1/10; H04L 29/08; G06N 3/08

(52) U.S. Cl. CPC G01W 1/10; G06N 3/08; H04L 67/12

(57) ABSTRACT

Disclosed herein is a method for facilitating forecasting of in-situ environmental conditions using nonlinear artificial neural networks-based models. Accordingly, the method may include receiving weather forecast model data, environmental data, and in-situ environmental data from an external device, analyzing the weather forecast model data, the environmental data, and the in-situ environmental data, generating input data, training a nonlinear machine learning-based in-situ environmental forecasting model based on the input data using a machine learning technique, validating the nonlinear machine learning-based in-situ environmental forecasting model using the in-situ environmental data, updating the nonlinear machine learning-based in-situ environmental forecasting model, generating an updated nonlinear machine learning-based in-situ environmental forecasting model, generating an in-situ forecast for an in-situ environmental condition, transmitting the in-situ forecast to a user device, and storing the nonlinear machine learning-based in-situ environmental forecasting model and the updated nonlinear machine learning-based in-situ environmental forecasting model.

The current application claims a priority to the U.S. Provisional Patent application Ser. No. 62/988,215 filed on Mar. 11, 2020.

### FIELD OF THE INVENTION

Generally, the present disclosure relates to the field of data processing. More specifically, the present disclosure relates to methods and systems for facilitating forecasting of in-situ environmental conditions using nonlinear artificial neural networks-based models.

### BACKGROUND OF THE INVENTION

Existing techniques for facilitating forecasting of in-situ environmental conditions using nonlinear artificial neural networks-based models are deficient with regard to several aspects. For instance, current forecasting systems use simplifications of fluid dynamics equations and sensor data from meteorological weather stations, radiosondes, weather balloons, buoys, and other sensors over the globe, to generate coarse-resolution gridded weather predictions at different time steps. Further, current forecasting systems do not generate forecast results that are optimized for specific locations. Further, current forecasting systems do not retrain and revalidate a statistical forecasting model based on the generated forecasts.

Therefore, there is a need for improved methods and systems for facilitating forecasting of in-situ environmental conditions using nonlinear artificial neural networks-based models that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for facilitating forecasting of in-situ environmental conditions using nonlinear artificial neural networks-based models, in accordance with some embodiments. Accordingly, the method may include receiving, using a communication device, weather forecast model data associated with a weather forecast model, one or more environmental data associated with one or more of one or more local environmental conditions, one or more regional environmental conditions, and one or more global environmental conditions, and one or more in-situ environmental data associated with one or more in-situ environmental conditions from at least one external device. Further, the method may include analyzing, using a processing device, the weather forecast model data, the one or more environmental data, and the one or more in-situ environmental data. Further, the method may include generating, using the processing device, input data based on the analyzing. Further, the method may include training, using the processing device, a nonlinear machine learning-based in-situ environmental forecasting model based on the input data using at least one machine learning technique. Further, the method may include validating, using the processing device, the nonlinear machine learning-based in-situ environmental forecasting model using the one or more in-situ environmental data of the input data based on the training. Further, the method may include updating, using the processing device, the nonlinear machine learning-based in-situ environmental forecasting model based on the validating. Further, the method may include generating, using the processing device, an updated nonlinear machine learning-based in-situ environmental forecasting model based on the updating. Further, the method may include generating, using the processing device, at least one in-situ forecast for at least one in-situ environmental condition based on the updated nonlinear machine learning-based in-situ environmental forecasting model. Further, the method may include transmitting, using the communication device, the at least one in-situ forecast to at least one user device. Further, the method may include storing, using a storage device, the nonlinear machine learning-based in-situ environmental forecasting model and the updated nonlinear machine learning-based in-situ environmental forecasting model.

Further disclosed herein is a system for facilitating forecasting of in-situ environmental conditions using nonlinear artificial neural networks-based models, in accordance with some embodiments. Accordingly, the system may include a communication device configured for receiving weather forecast model data associated with a weather forecast model, one or more environmental data associated with one or more of one or more local environmental conditions, one or more regional environmental conditions, and one or more global environmental conditions, and one or more in-situ environmental data associated with one or more in-situ environmental conditions from at least one external device. Further, the communication device may be configured for transmitting at least one in-situ forecast to at least one user device. Further, the system may include a processing device communicatively coupled with the communication device. Further, the processing device may be configured for analyzing the weather forecast model data, the one or more environmental data, and the one or more in-situ environmental data. Further, the processing device may be configured for generating input data based on the analyzing. Further, the processing device may be configured for training a nonlinear machine learning-based in-situ environmental forecasting model based on the input data using at least one machine learning technique. Further, the processing device may be configured for validating the nonlinear machine learning-based in-situ environmental forecasting model using the one or more in-situ environmental data of the input data based on the training. Further, the processing device may be configured for updating the nonlinear machine learning-based in-situ environmental forecasting model based on the validating. Further, the processing device may be configured for generating an updated nonlinear machine learning-based in-situ environmental forecasting model based on the updating. Further, the processing device may be configured for generating the at least one in-situ forecast for at least one in-situ environmental condition based on the updated nonlinear machine learning-based in-situ environmental forecasting model. Further, the system may include a storage device communicatively coupled with the processing device. Further, the storage device may be configured for storing the nonlinear machine learning-based in-situ environmental forecasting model and the updated nonlinear machine learning-based in-situ environmental forecasting model.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a schematic of a global environmental data assimilation system, in accordance with some embodiments.

FIG. 2 illustrates a simplified environment for monitoring environmental conditions, in accordance with some embodiments.

FIG. 3 is a block diagram of a system for predicting in-situ environmental conditions, in accordance with some embodiments.

FIG. 4 is a block diagram of a system architecture diagram of an in-situ environmental conditions forecasting system, in accordance with some embodiments.

FIG. 5 is a flow diagram of a method for periodic retrieval of data, in accordance with some embodiments.

FIG. 6 is a flow diagram of a method for receiving sensor data, in accordance with some embodiments.

FIG. 7 is a flow diagram of a method for generating in-situ forecast data using a back-end system, in accordance with some embodiments.

FIG. 8 is a flow diagram of a method for providing in-situ forecast data using a front-end system, in accordance with some embodiments.

FIG. 9 is a block diagram of a computing device of the in-situ prediction system, in accordance with some embodiments.

FIG. 10 is a block diagram of a system for facilitating forecasting of in-situ environmental conditions using nonlinear artificial neural networks-based models, in accordance with some embodiments.

FIG. 11 is a flowchart of a method for facilitating forecasting of in-situ environmental conditions using nonlinear artificial neural networks-based models, in accordance with some embodiments.

FIG. 12 is a flowchart of a method for receiving at least one in-situ environmental condition indication for facilitating the forecasting the in-situ environmental conditions using the nonlinear artificial neural networks-based models, in accordance with some embodiments.

FIG. 13 is a flowchart of a method for generating at least one processed in-situ forecast for facilitating the forecasting the in-situ environmental conditions using the nonlinear artificial neural networks-based models, in accordance with some embodiments.

FIG. 14 is a flowchart of a method for reupdating the nonlinear machine learning-based in-situ environmental forecasting model for facilitating the forecasting the in-situ environmental conditions using the nonlinear artificial neural networks-based models, in accordance with some embodiments.

FIG. 15 is an illustration of an online platform consistent with various embodiments of the present disclosure.

FIG. 16 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods and systems for facilitating forecasting of in-situ environmental conditions using nonlinear artificial neural networks-based models, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

Overview:

The present disclosure describes methods and systems for facilitating forecasting of in-situ environmental conditions using nonlinear artificial neural networks-based models. Further, the disclosed system may be configured for predicting in-situ environmental conditions for one or more environmental variables of interest-based on machine learning algorithms. Further, the disclosed system may include a machine learning engine that implements a nonlinear regression like feedforward neural network, support vector regression, quantile regression, or similar techniques. Further, the disclosed system may be configured for environmental forecasting using nonlinear artificial neural networks-based models. Further, the disclosed system may be configured for forecasting in-situ atmospheric, biological, and physiological conditions based on in-situ measurements, and past, present, and future weather data at a regional and global level and fine-tuned using in-situ observational data.

Further, environmental sensors may measure and monitor different aspects of our environment. For example, satellites may be used to measure infrared radiation, water content, and other environmental variables, soil moisture sensors monitor the water content of the soils, weather stations contain sensors that measure meteorological conditions such as rainfall, temperature, solar radiation, and wind speed and direction, while Radar measure range, angle, and velocity of weather formations and terrain. Further, governments, individuals, and businesses may install local meteorological environmental sensors, like weather stations, to provide current local conditions, but rely on forecasting models, both regional and global to generate future environmental predictions. Further, private companies and national agencies produce global and regional weather predictions operationally.

As weather, especially extreme weather events, continue to affect various industries, and a wide range of individual assets, more accurate weather models for a given location are necessary. Further, the disclosed system for in-situ weather forecasting using a nonlinear machine-learning-based model (or model), like artificial neural networks. Further, the disclosed system may be configured for numerical weather forecasting global and/or regional data, in addition to in-situ, remote, local, and/or regional observational data; and fine-tuned using observational in-situ data.

Further, the disclosed system may be configured for generating forecasts for variables measured at individual IoT sensors, not wider areas. Further, the disclosed system does not produce spatial maps like traditional weather forecasts as the results are optimized for specific locations.

Further, the disclosed system may be configured for continuously updating the model parameters (weights) as more data is assimilated by the disclosed system. Further, most of the existing applications train their statistical models and once they have a good model, the existing applications use it to produce the forecasts, in contrast, the disclosed system may be configured for re-training and validating the model as more data comes in. Further, the disclosed system may be configured for sharing the forecasts with the customers via APIs, mobile, and desktop interfaces that allow the customer to ingest relevant in-situ data that is used in turn to improve the forecasts. Further, the disclosed system may use an online sequential extreme learning machine for operational environmental forecasting.

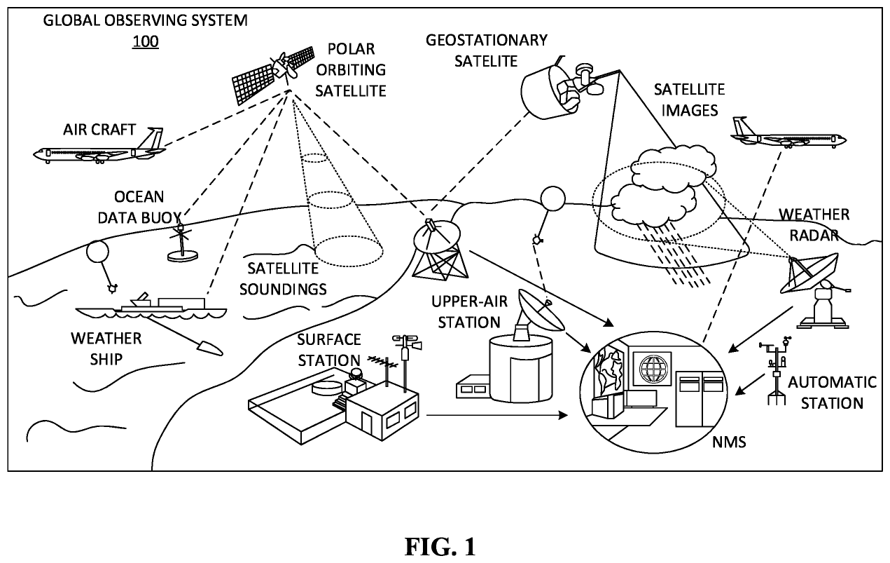

Referring now to figures, FIG. 1 is a schematic of a global environmental data assimilation system 100, in accordance with some embodiments. Accordingly, a Global Observing System (GOS) (such as the environmental data assimilation system 100) provides observations on the state of the atmosphere and ocean surface from the land-based and space-based instruments. Further, data associated with the GOS may be used for the preparation of weather analyses, forecasts, advisories, and warnings, and for the climate monitoring and environmental activities carried out through other programs as well as by other international organizations. Further, the Global Observing System may be operated by National Meteorological and Hydrological Services (NMHSs), national or international satellite agencies, and involves several consortia dealing with specific observing systems or specific geographic regions.

Further, the Global Observing System observes, records, and reports, and aids the preparation of operational weather and climate forecasts, and warning services as well as other derived services. It also contributes to the delivery of warnings of severe weather, climate, water-related and environmental events around the world.

Operational numerical weather forecasts from National Meteorological Organizations such as NOAA's Rapid Refresh Model weather model or RAP receive data from environmental sensors from the Global Observing System (GOS). For instance, regional and global weather forecasting services use predominantly data from the GOS' environmental monitoring sensors to generate regularly spaced weather forecasts.

Further, end-users often use local environmental forecasts from numerical weather models to aid in their decision-making. However, numerical forecasting models' coarse spatial resolution prevents them from resolving, small-scale dynamical features, local orographic effects, and other regional physiographical features. Thus, accurate local estimates of observed climate are unlikely to be produced.

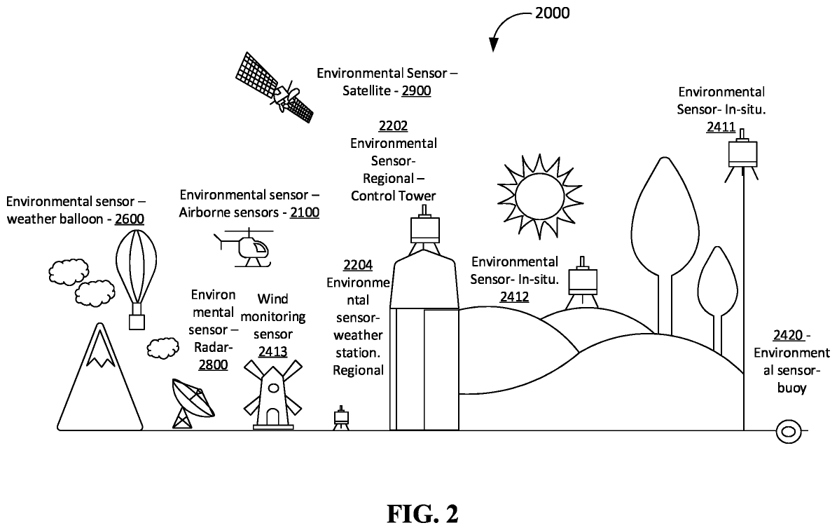

FIG. 2 illustrates a simplified environment 2000 for monitoring environmental conditions, in accordance with some embodiments. Accordingly, the simplified environment 2000 includes one or more sensors like airborne sensors 2100, in-situ environmental sensors over land at different height levels (e.g. 2411, 2412, and wind monitoring sensors 2413), and over water surfaces 2420, such as a buoy. Further, the simplified environment 2000 may also include environmental sensors on weather balloons 2600, radar measurements 2800, and environmental sensors from satellites 2900. The satellite may include but is not limited to, geostationary, low-earth orbit, medium earth orbit, high-earth orbit, the geostationary orbit, polar orbit, but also a combination of them. For purposes of description, the simplified environment 2000 is a combination of in-situ, local, regional, and/or global environmental conditions.

In situ environmental conditions are often needed as the energy sector, hydrological and actuarial sciences, engineering studies, and the impacts and adaptation community among others, regularly use local-scale information. Regional environmental monitoring sensors 2202, 2204, and in-situ monitoring sensors (e.g., such as the in-situ environmental sensors 2411, 2412, 2420) may be traditionally used to aid in the decision-making process of the users.

Further, the regional environmental monitoring sensors (or environmental monitoring sensors) 2202 may be irregularly spaced apart from one another and can be positioned at a particular location and elevation to determine in-situ environmental conditions, such as temperature, humidity, and wind speed, or plant-health related variables such as chlorophyll content. For instance, temperature sensors in each of the regional environmental monitoring stations (e.g., regional control tower 2202, weather station regional sensor 2204) are usually positioned 2 meters above ground level, while wind monitoring sensors 2413 may be traditionally positioned 10 meters above ground level.

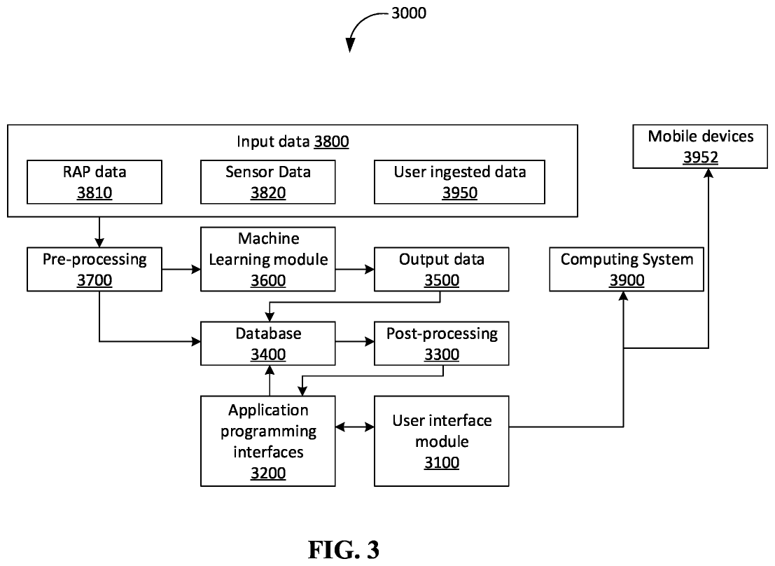

FIG. 3 is a block diagram of a system 3000 for predicting in-situ environmental conditions, in accordance with some embodiments. Accordingly, the system 3000 includes various subsystems including a user interface module 3100, application programming interfaces or APIs 3200, a post processing module 3300, a database (or similar data store) 3400, output data 3500, consisting of in-situ forecasts, a machine learning module 3600, for example, a genetic programming algorithm, a support vector regression, or an Artificial Neural Network (ANN), a pre-processing module 3700, a computing system 3900, and an input data 3800. Further, the input data 3800 may include RAP data 3810, environmental sensor data (or sensor data) 3820, and a user ingested data 3950.

Further, the user interface module 3100 allows users, including administrators to log into the system 3000 and receive data from the system 3000. Suitable computing devices may be used to log into the system 3000. The user interface module 3100 may transmit via text or graphical information relevant alerts. Further, the user ingested data 3950 may be associated with mobile devices 3952. Further, the mobile phones (devices) 3952 and the computing systems 3900 may be used to receive the alerts, dashboards, reports, and in-situ forecasts, for example.

Further, the APIs 3200 may retrieve environmental data from various sources. For example, a first API associated with the APIs 3200 may retrieve numerical weather model data from one or more services like the RAP. Further, another API associated with the APIs 3200 may retrieve local atmospheric measurement data (or the sensor data 3820) from sensor devices like the ones found at weather monitoring stations; a third API associated with the APIs 3200 may retrieve user ingested data, like management decisions, plant health status, or other actions and observations taken at a local scale.

Further, the database 3400, may store sensor data, numerical weather model data, and user ingested data, including but not limited to account and login information, obtained via the user interface module 3100. Further, the data pre-processing may be performed by the pre-processing module 3700 and data post-processing may be performed by the post processing module 3300. Further, the data pre-processing and the data post-processing may be used before and after the machine learning module 3600. The database 3400 may also store training data for the machine learning module 3600 as well as algorithms, parameters, and weights determined by or used by the machine learning module 3600.

Further, the machine learning module 3600 uses machine learning algorithms to predict in-situ environmental conditions for one or more environmental variables of interest. The in-situ forecasts may be generated for the locations with environmental sensor data. The machine learning module 3600 determines in-situ forecasts using numerical weather model data from models like the RAP data 3810, local environmental data (such as the sensor data 3820) from the sensor devices, and, when available, the user ingested data 3950.

Further, the Machine Learning module (or Machine Learning engine) 3600 implements a nonlinear regression like feedforward neural network, support vector regression, quantile regression, or similar techniques. Further, a machine learning-based model associated with the Machine Learning engine 3600 may be updated as new data arrives from either the local data from the sensor devices 3850 or the data from the RAP services. Hourly forecasts from RAP services may be obtained 24 times per day. Local sensor data may be retrieved periodically (e.g., 15-minute intervals) or received when sent by local weather monitoring stations (e.g., daily, sub-daily). Furthermore, the machine learning engine 3600 determines an appropriate set of predictors to predict in-situ environmental conditions from the input data 3800 available.

Further, the pre-processing module 3700 may be configured for natural language processing of the user ingested data 3950, gap filing, outlier detection and tagging of the sensor data 3820, error handling steps (e.g., removal of flags, finding, handling, and removing duplicate data), spatial re-gridding and data homogenization of numerical weather models, time axis homogenization to a common time zone (e.g., EST, PST, UTC), and predictor selection from the input data 3800, among other steps.

Throughout this disclosure, the computing system 3900, might include single or multiple processors, a single or multiple graphics processing units, and single or multiple memory components, including but not limited to main and/or static memories, which communicate via a system bus. The Computing System 3900 may also include a video display to show outputs to the end-user. Furthermore, the computing system 3900 may include input devices, such as alpha-numeric input devices, biometric verification units, voice-recognition units, and a cursor control device such as a mouse, trackpad, or track pen, or touch-screen units. The computing system 3900 may include a data encryption module, network interface devices, and signal generation devices, such as speakers. Examples of computing systems include a personal computer (PC), a cellular telephone, a web or network appliance, and any system with the capability of executing sequential or parallel instructions to be taken by the system.

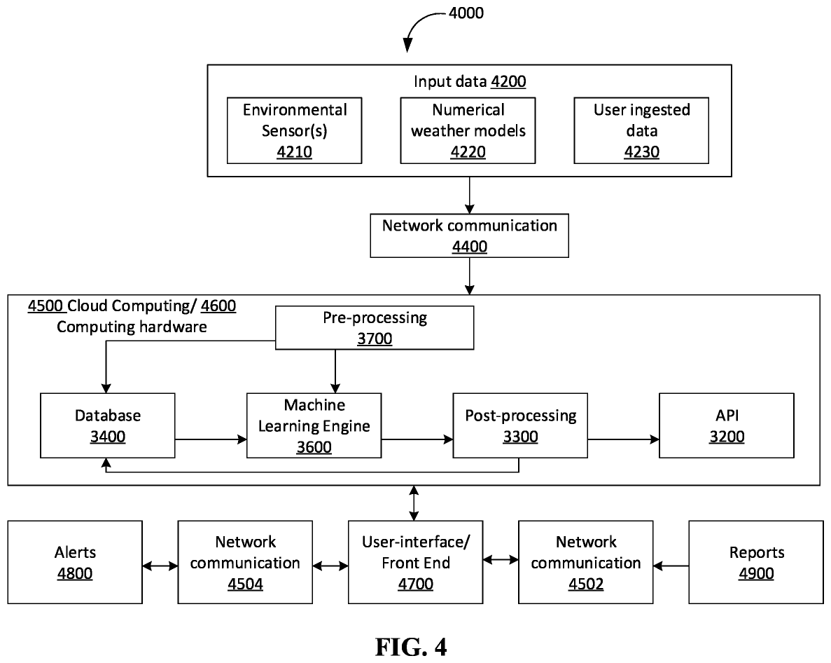

FIG. 4 is a block diagram of a system architecture diagram of an in-situ environmental conditions forecasting system 4000, in accordance with some embodiments. Accordingly, data from one or more environmental sensors 4210, one or more numerical weather models 4220, and/or user ingested data 4230 create the dataset known as input data 4200.

Further, single or multiple networks 4400 may receive the input data 4200 and transmit it to a computing service, like a local computing service, such as a back-end server, a dedicated computing hardware 4600, a cloud computing service 4500 (e.g., Amazon™ Web Service, Microsoft™ Azure Cloud, Google™ Cloud Platform), and a combination of local services and virtualized services as would be understood in the art. Further, the single or multiple networks 4400 (or network communication module) may include cellular data networks, the internet, local intranets, or similar data networks.

Further, the cloud computing services 4500 and/or the computing hardware 4600 may receive the input data 4200 via the network communication module 4400. Further, the cloud computing services 4500 and computing hardware (or computing hardware module) 4600 may process the input data 4200. Typical processing steps include but are not limited to, pre-processing 3700, model training, testing and validation steps of the machine learning engine 3600, and post-processing steps 3300, like data quality control operations. Further, the cloud computing services 4500 and the computing hardware 4600 may be also used to store, compute and communicate via one or more networks, one or more functions of the in-situ environmental conditions forecasting system 4000. Further, in an embodiment, the forecasting system 4000 may include the APIs 3200 deployed in the cloud computing services (or cloud computing platform) 4500, while user interface 4700 and web server functions are hosted by the computing hardware 4600 like a network server.

Further, the user interface 4700 receives information from the cloud computing services (or cloud computing module) 4500 and/or the computing hardware 4600. Further, in an embodiment, the system architecture of the in-situ environmental conditions forecasting system 4000 may include a network communication module 4504 to receive and transmit data to and from the user interface 4700. Further, in an exemplary embodiment, the in-situ environmental conditions forecasting system 4000 includes an alert module 4800 and a report module 4900. The alert module 4800 may operate as an input-output component, where the user receives alerts issued by the cloud computing 4500 and/or the computing hardware module 4600. The alert module 4800 may also be used to report local alerts to the system, in addition to the ones generated by the cloud computing 4500 and/or computing hardware module 4600. The report module 4900 generates specific reports of in-situ environmental conditions. Examples of reports include printed information of in-situ environmental conditions, electronic generation of files containing the in-situ environmental conditions, and visual or audible content with relevant in-field data. Reports associated with the report module 4900 may also be generated as web pages to be viewed on mobile devices, personal computers, web appliances, or any other system with the capability of executing sequential or parallel instructions transmitted by a suitable network communication module 4502. The user interface 4700 may also allow administrators and other users to perform administrative tasks, like selecting measuring units, communication preferences, report generation preferences, alert preferences, among other related tasks.

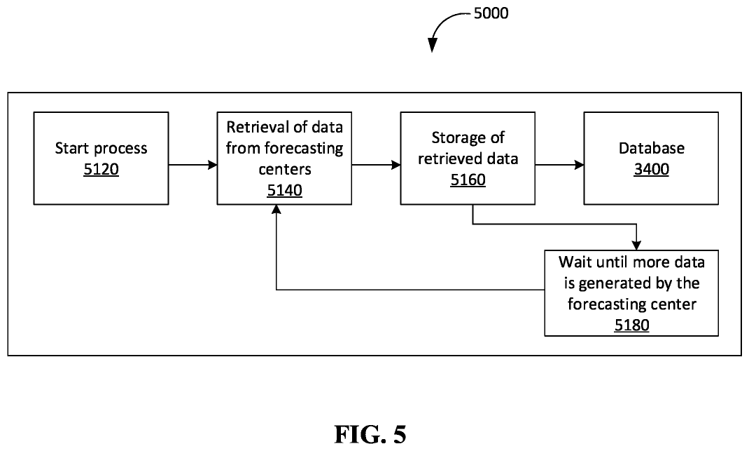

FIG. 5 is a flow diagram of a method 5000 for periodic retrieval of data, in accordance with some embodiments. Accordingly, at 5120, the method 5000 may include initiating the action of environmental data (or the data) retrieval based on a start process module. Further, at 5140, the method 5000 may include the retrieval of the data from forecasting centers. Further, at 5160, the method 5000 may include storing the data (or retrieved data) in a data store, memory or similar component. Further, the database 3400 may be used to access the stored data. Further, at 5180, the method 5000 may include waiting until more data is generated by the forecasting center. Further, the method 5000 may include checking if new environmental data may be retrieved from the forecasting centres, like NOAA. Further, upon retrieving of the data (such as the new environmental data), the method 5000 may proceed to 5140, retrieval of data from forecasting centers.

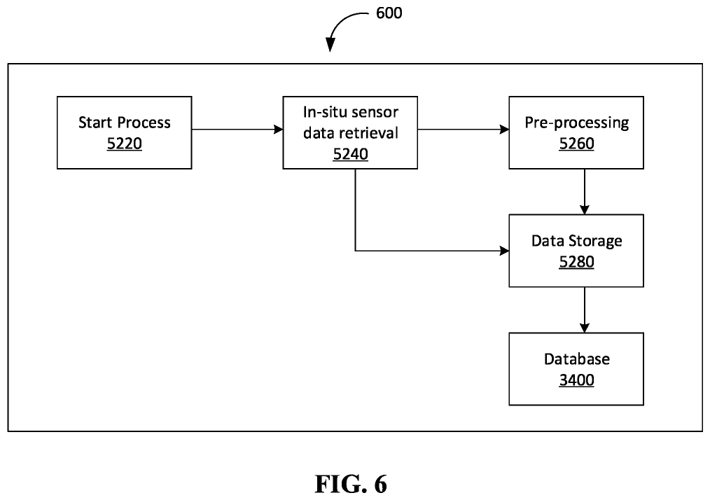

FIG. 6 is a flow diagram of a method 600 for receiving sensor data, in accordance with some embodiments. Accordingly, at 5220, the method 600 may include initiating receiving of the sensor data. Further, at 5240, the method 600 may include retrieving of in-situ sensor data retrieval (or the sensor data). Once the in-situ data is retrieved, the method 600 may include storing the sensor data in a data storage medium. Further, at 5260, the method 600 may include pre-processing. Further, the pre-processing may include error detection, handling and correction, data homogenization and file formatting compliance, and data integrity, among other actions. Further, at 5280, the method 600 may include storing data (or the in-situ sensor data). Further, a data storage medium may be accessed via the database 3400 or similar solutions.

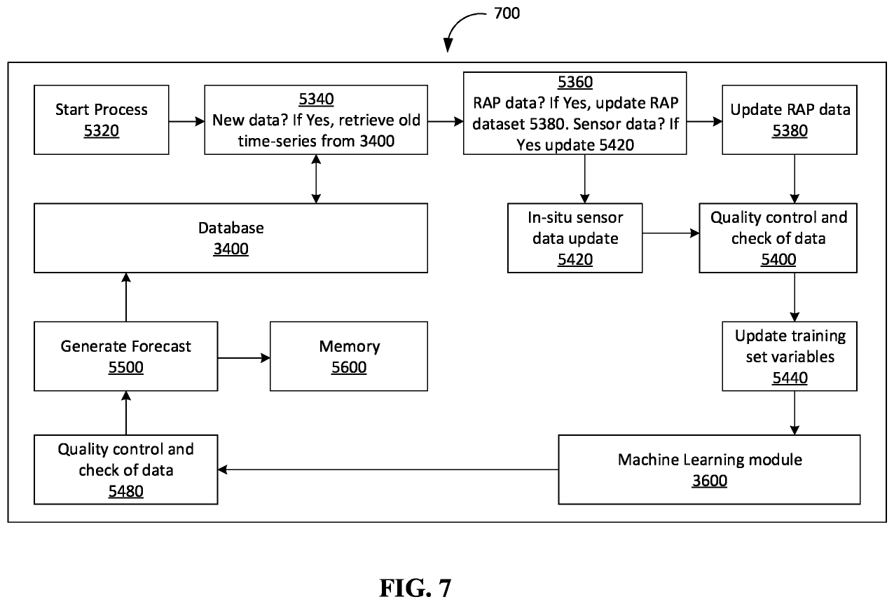

FIG. 7 is a flow diagram of a method 700 for generating in-situ forecast data using a back-end system, in accordance with some embodiments. Accordingly, at 5320, the method 700 may include beginning with a start process instruction that initiates the subsequent routines. After receiving the start process instruction, at 5340, the method 700 may include checking if new data has been incorporated into the database 3400. If new data was found in the database 3400, a previous environmental time-series data may be retrieved. Further, at 5360, the method 700 may include checking if the new data corresponds to numerical weather models, like the RAP, or if it corresponds to in-situ sensor data. If the new data corresponds to in-situ data (or in-situ sensor data), at 5420, the method 700 may include updating corresponding time-series associated with the in-situ data, and then at 5400, quality checks and quality control routines are run on the updated time-series. Further, the method 700 may proceed after 5380 to 5400. If the new data belongs to numerical weather models, then at 5380, the method 700 may include executing updating routine to update the corresponding time-series. Further, at 5400, the method 700 may include quality control and quality check operations to be run on updated data that may include updating RAP data and updated in-situ sensor data. Further, at 5440, the method 700 may include updating the training set variables and are then used appropriately by the machine learning module 3600. After the machine learning module 3600 produces the updated forecasts, at 5480, quality control and checks may be performed on the forecasted data, then at 5500, forecasts may be generated and stored in the database 3400 and/or in a memory 5600 so the forecasts may be accessed, reported, and/or visualized. The quality control and check of data module may include data integrity checks like ensuring that the data contains realistic values, checking for missing values, error handling and tagging, and data formatting issues like guaranteeing the number of decimal positions and ensuring that the file type used to save the data is supported by the database 3400.

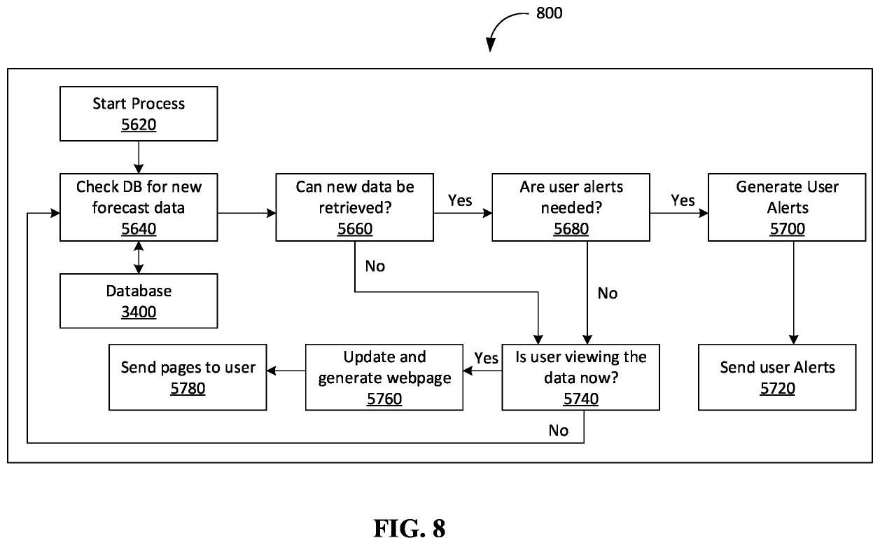

FIG. 8 is a flow diagram of a method 800 for providing in-situ forecast data using a front-end system, in accordance with some embodiments. Accordingly, at 5620, the method 800 may include starting with a module start process. Further, at 5640, the method 800 may include checking a database for new forecast data (or new forecast process), where the database 3400 is consulted. Further, at 5660, the method 800 may include checking if new data can be retrieved by the user. Further, if the new data may be retrieved, at 5680, the method 800 may include verifying if new alerts (or user alerts) are needed. Further, if the new alerts are needed, at 5700, the method 800 may include generating user alerts. Further, at 5720, the method 800 may include sending the alerts to the users. Further, if the new data cannot be retrieved or if the user does not need new alerts in process, then at 5740, the method 800 may include checking if the user is currently viewing the data. If the user is not viewing the data, the method 800 may proceed to 5640 and checks for new forecast data. If the user is viewing the data, at 5760, the method 800 may include updating and/or generating a new webpage. Further, at 5780, the method 800 may include sending new pages to the user.

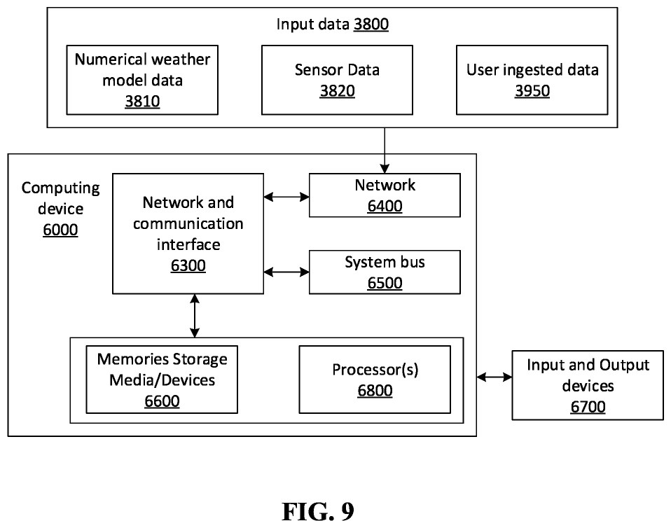

FIG. 9 is a block diagram of a computing device 6000 of the in-situ prediction system, in accordance with some embodiments. The systems and processes described above can be performed on or between one or more computing devices. Further, the computing device 6000 may be connected via a network to other machines and operate as servers, client machines or peer machines in distributed or peer to peer networks.

Further, the computing device 6000 may include a processor 6800 and memory (non-volatile, main or static) 6600. Further, the processor 6800 and memory (non-volatile, main or static) 6600 may also constitute machine-readable media, both the processor 6800 and the memory 6600, communicate via a system bus 6500, and may handle instructions residing fully or as a fraction within them. The memory (or memory storage media/devices) 6600 may store computer-readable instructions, data, data structures, program modules, code, including microcode, and other software components to carry out the methodologies described in this disclosure. Further, the computing device 6000 may be communicatively coupled to input devices and output devices 6700.

Environmental sensor devices may monitor, record, and transmit the sensor data 3820 for determining environmental conditions like soil properties and plant conditions. Further, the environmental sensor devices may also transmit a terrestrial position of the sensors via Global positioning systems (GPS). Environmental sensor devices might also monitor, record, and transmit the sensor status, performance, and hardware characteristics.

The Internet service may be configured to provide Internet access to one or more computing devices that are coupled to the internet service. The instructions may be transmitted or received over a network 6400 via a network interface device 6300 (or network and communication interface). Further, the instructions may be transmitted using any of the well-known transfer protocols such as HTTP. Moreover, the Internet service may be coupled to one or more databases, repositories, and servers, including machine-readable mediums. While the machine-readable medium is shown in an example embodiment to be a single medium, the term “computer-readable medium” should be taken to include a single medium or multiple media that may store one or more sets of instructions. It would be appreciated by those skilled in the art that the internet service, in conjunction with, one or more machine-readable mediums may be utilized to implement any of the example embodiments presented here.

The term “computer-readable medium” shall accordingly be taken to include, but not be limited to, solid-state memories, optical and magnetic media, and carrier wave signals. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions

Further, a single component can be replaced by multiple components and multiple components can be replaced by a single component to perform a given function or a group of related functions. Except where such components cannot be grouped operationally, such substitution is within the intended scope of the embodiments. The computing resources can also include distributed computing devices, cloud computing resources, and virtual computing resources in general. Those details disclosed here are not to be interpreted in any form as limiting but as the basis for the claims.

Further, the term “machine” shall be taken to include any collection of machines that individually or jointly execute a set (or multiple sets) of instructions to perform any one or more of the methodologies discussed herein. The term “software” shall be taken to include executable code, data structures, data stores, and computing instructions stored in any suitable electronic format, including firmware, and software embedded in hardware, including non-PC devices. The instructions or functions may be implemented as part of a different component or module, although for clarity this disclosure might describe specific features or functions as part of a certain module or component.

In various example embodiments, the machine operates as a standalone device or may be connected (e.g., networked) to other machines. The present disclosure is directed to a system of one or more computers. In a networked deployment, the machine may operate as a peer machine in a peer-to-peer network environment, or as a server or a client machine in a server-client network environment. The system may have installed a combination of software, hardware, and firmware to perform specific operations or actions. Where the example machine refers to any machine capable of executing a set of instructions in parallel or sequentially (e.g., personal computer (PC), cellular telephone, web-enabled appliance).

In the description of embodiments, for purposes of explanation and not limitation, specific details are set forth. The description is not intended to be exhaustive or limited to the forms described; to the contrary, the present descriptions are intended to cover such alternatives, modifications, and equivalents as may be included within the spirit and scope of the present technology. Numerous modifications are possible in light of the above teachings. However, it will be apparent to one skilled in the art that the present technology may be practiced in other embodiments that depart from these specific details. Thus, the breadth and scope of a preferred embodiment should not be limited by any of the above-described exemplary embodiments.

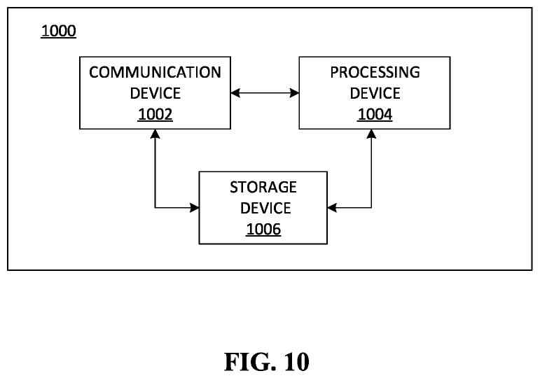

FIG. 10 is a block diagram of a system 1000 for facilitating forecasting of in-situ environmental conditions using nonlinear artificial neural networks-based models, in accordance with some embodiments. Accordingly, the system 1000 may include a communication device 1002 configured for receiving weather forecast model data associated with a weather forecast model, one or more environmental data associated with one or more of one or more local environmental conditions, one or more regional environmental conditions, and one or more global environmental conditions, and one or more in-situ environmental data associated with one or more in-situ environmental conditions from at least one external device. Further, the communication device 1002 may be configured for transmitting at least one in-situ forecast to at least one user device.

Further, the system 1000 may include a processing device 1004 communicatively coupled with the communication device 1002. Further, the processing device 1004 may be configured for analyzing the weather forecast model data, the one or more environmental data, and the one or more in-situ environmental data. Further, the processing device 1004 may be configured for generating input data based on the analyzing. Further, the processing device 1004 may be configured for training a nonlinear machine learning-based in-situ environmental forecasting model based on the input data using at least one machine learning technique. Further, the processing device 1004 may be configured for validating the nonlinear machine learning-based in-situ environmental forecasting model using the one or more in-situ environmental data of the input data based on the training. Further, the processing device 1004 may be configured for updating the nonlinear machine learning-based in-situ environmental forecasting model based on the validating. Further, the processing device 1004 may be configured for generating an updated nonlinear machine learning-based in-situ environmental forecasting model based on the updating. Further, the processing device 1004 may be configured for generating the at least one in-situ forecast for at least one in-situ environmental condition based on the updated nonlinear machine learning-based in-situ environmental forecasting model.

Further, the system 1000 may include a storage device 1006 communicatively coupled with the processing device 1004. Further, the storage device 1006 may be configured for storing the nonlinear machine learning-based in-situ environmental forecasting model and the updated nonlinear machine learning-based in-situ environmental forecasting model.

Further, in some embodiments, the at least one machine learning technique may include a nonlinear regression. Further, the nonlinear regression may include at least one of a feedforward neural network, a support vector regression, and a quantile regression.

Further, in some embodiments, the communication device 1002 may be configured for receiving at least one in-situ environmental condition indication from the at least one user device. Further, the processing device 1004 may be configured for identifying the at least one in-situ environmental condition associated with the at least one in-situ environmental condition indication. Further, the generating of the at least one in-situ forecast for the at least one in-situ environmental condition may be based on the identifying.

Further, in some embodiments, the at least one external device may include one or more in-situ environmental sensors. Further, the one or more in-situ environmental sensors are disposed in one or more locations at one or more elevations. Further, the one or more in-situ environmental sensors are configured for generating the one or more in-situ environmental data associated with the one or more in-situ environmental conditions at the one or more elevations of the one or more locations. Further, the at least one in-situ forecast for the at least one in-situ environmental condition may be associated with the one or more locations.

Further, in some embodiments, the communication device 1002 may be configured for receiving at least one user environmental data associated with one or more of the one or more local environmental conditions, the one or more regional environmental conditions, the one or more global environmental conditions, and the one or more in-situ environmental conditions from the at least one user device. Further, the generating of the input data may be based on the at least one user environmental data.

Further, in some embodiments, the analyzing of the weather forecast model data, the one or more environmental data, and the one or more in-situ environmental data may include preprocessing the weather forecast model data, the one or more environmental data, and the one or more in-situ environmental data. Further, the preprocessing may include performing at least one data cleaning action on the weather forecast model data, the one or more environmental data, and the one or more in-situ environmental data. Further, the generating of the input data may be based on the preprocessing. Further, the at least one data cleaning action may include error detection, handling and correction, data homogenization and file formatting compliance, and data integrity, among other actions

Further, in some embodiments, the processing device 1004 may be configured for post-processing the at least one in-situ forecast based on the generating of the at least one in-situ forecast. Further, the post-processing may include performing at least one data quality control operation on the at least one in-situ forecast. Further, the processing device 1004 may be configured for generating at least one processed in-situ forecast based on the post-processing. Further, the communication device 1002 may be configured for transmitting the at least one processed in-situ forecast to the at least one user device.

Further, in some embodiments, the communication device 1002 may be configured for receiving current weather forecast model data associated with the weather forecast model, one or more current environmental data associated with the one or more of the one or more local environmental conditions, the one or more regional environmental conditions, and the one or more global environmental conditions, and one or more current in-situ environmental data associated with the one or more in-situ environmental conditions from the at least one external device. Further, the processing device 1004 may be configured for incorporating the current weather forecast model data, the one or more current environmental data, and the one or more current in-situ environmental data with the input data. Further, the processing device 1004 may be configured for generating updated input data based on the incorporating, Further, the processing device 1004 may be configured for retraining the nonlinear machine learning-based in-situ environmental forecasting model based on the updated input data using the at least one machine learning technique. Further, the processing device 1004 may be configured for revalidating the nonlinear machine learning-based in-situ environmental forecasting model using the one or more current in-situ environmental data of the updated input data based on the retraining. Further, the processing device 1004 may be configured for reupdating the nonlinear machine learning-based in-situ environmental forecasting model based on the revalidating. Further, the generating of the updated nonlinear machine learning-based in-situ environmental forecasting model may be based on the reupdating.

Further, in some embodiments, the processing device 1004 may be configured for generating a data retrieve indication based on at least one operational criterion. Further, the data retrieve indication corresponds to an instance for retrieving the current weather forecast model data, the one or more current environmental data, and the one or more current in-situ environmental data from the at least one external device. Further, the at least one external device may include the current weather forecast model data, the one or more current environmental data, and the one or more current in-situ environmental data at the instance. Further, the receiving of the current weather forecast model data, the one or more current environmental data, and the one or more current in-situ environmental data may be based on the data retrieve indication.

Further, in some embodiments, the processing device 1004 may be configured for preprocessing the current weather forecast model data, the one or more current environmental data, and the one or more current in-situ environmental data. Further, the preprocessing may include performing at least one data cleaning action on the current weather forecast model data, the one or more current environmental data, and the one or more current in-situ environmental data. Further, the incorporating of the current weather forecast model data, the one or more current environmental data, and the one or more current in-situ environmental data with the input data may be based on the preprocessing.

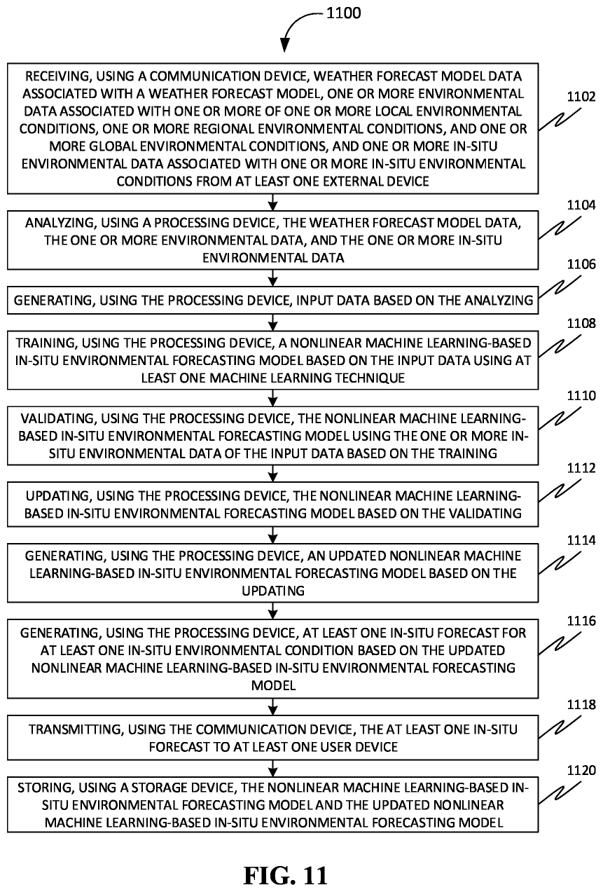

FIG. 11 is a flowchart of a method 1100 for facilitating forecasting of in-situ environmental conditions using nonlinear artificial neural networks-based models, in accordance with some embodiments. Accordingly, at 1102, the method 1100 may include receiving, using a communication device (such as the communication device 1002), weather forecast model data associated with a weather forecast model, one or more environmental data associated with one or more of one or more local environmental conditions, one or more regional environmental conditions, and one or more global environmental conditions, and one or more in-situ environmental data associated with one or more in-situ environmental conditions from at least one external device.

Further, at 1104, the method 1100 may include analyzing, using a processing device (such as the processing device 1004), the weather forecast model data, the one or more environmental data, and the one or more in-situ environmental data.

Further, at 1106, the method 1100 may include generating, using the processing device, input data based on the analyzing.

Further, at 1108, the method 1100 may include training, using the processing device, a nonlinear machine learning-based in-situ environmental forecasting model based on the input data using at least one machine learning technique.

Further, at 1110, the method 1100 may include validating, using the processing device, the nonlinear machine learning-based in-situ environmental forecasting model using the one or more in-situ environmental data of the input data based on the training.

Further, at 1112, the method 1100 may include updating, using the processing device, the nonlinear machine learning-based in-situ environmental forecasting model based on the validating.

Further, at 1114, the method 1100 may include generating, using the processing device, an updated nonlinear machine learning-based in-situ environmental forecasting model based on the updating.

Further, at 1116, the method 1100 may include generating, using the processing device, at least one in-situ forecast for at least one in-situ environmental condition based on the updated nonlinear machine learning-based in-situ environmental forecasting model.

Further, at 1118, the method 1100 may include transmitting, using the communication device, the at least one in-situ forecast to at least one user device.

Further, at 1120, the method 1100 may include storing, using a storage device (such as the storage device 1006), the nonlinear machine learning-based in-situ environmental forecasting model and the updated nonlinear machine learning-based in-situ environmental forecasting model.

Further, in some embodiments, the at least one machine learning technique may include a nonlinear regression. Further, the nonlinear regression may include at least one of a feedforward neural network, a support vector regression, and a quantile regression.

Further, in some embodiments, the at least one external device may include one or more in-situ environmental sensors. Further, the one or more in-situ environmental sensors are disposed in one or more locations at one or more elevations. Further, the one or more in-situ environmental sensors are configured for generating the one or more in-situ environmental data associated with the one or more in-situ environmental conditions at the one or more elevations of the one or more locations. Further, the at least one in-situ forecast for the at least one in-situ environmental condition may be associated with the one or more locations.

Further, in an embodiment, the method 1100 may include receiving, using the communication device, at least one user environmental data associated with one or more of the one or more local environmental conditions, the one or more regional environmental conditions, the one or more global environmental conditions, and the one or more in-situ environmental conditions from the at least one user device. Further, the generating of the input data may be based on the at least one user environmental data.

Further, in some embodiment, the analyzing of the weather forecast model data, the one or more environmental data, and the one or more in-situ environmental data may include preprocessing the weather forecast model data, the one or more environmental data, and the one or more in-situ environmental data. Further, the preprocessing may include performing at least one data cleaning action on the weather forecast model data, the one or more environmental data, and the one or more in-situ environmental data. Further, the generating of the input data may be based on the preprocessing. Further, the at least one data cleaning action may include error detection, handling and correction, data homogenization and file formatting compliance, and data integrity, among other actions

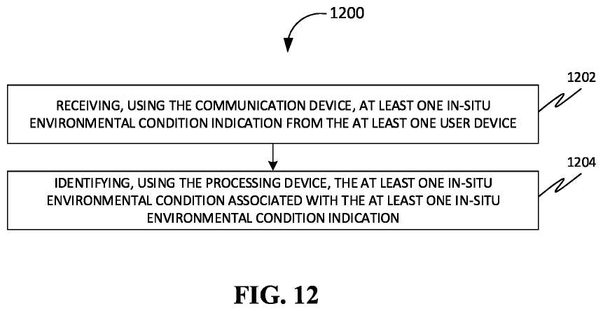

FIG. 12 is a flowchart of a method 1200 for receiving at least one in-situ environmental condition indication for facilitating the forecasting the in-situ environmental conditions using the nonlinear artificial neural networks-based models, in accordance with some embodiments. Accordingly, at 1202, the method 1200 may include receiving, using the communication device, at least one in-situ environmental condition indication from the at least one user device.

Further, at 1204, the method 1200 may include identifying, using the processing device, the at least one in-situ environmental condition associated with the at least one in-situ environmental condition indication. Further, the generating of the at least one in-situ forecast for the at least one in-situ environmental condition may be based on the identifying.

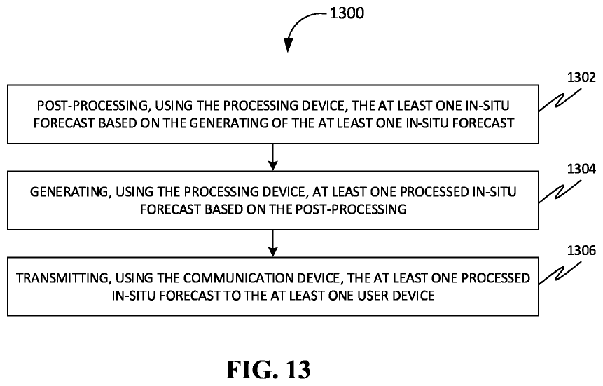

FIG. 13 is a flowchart of a method 1300 for generating at least one processed in-situ forecast for facilitating the forecasting the in-situ environmental conditions using the nonlinear artificial neural networks-based models, in accordance with some embodiments. Accordingly, at 1302, the method 1300 may include post-processing, using the processing device, the at least one in-situ forecast based on the generating of the at least one in-situ forecast. Further, the post-processing may include performing at least one data quality control operation on the at least one in-situ forecast.

Further, at 1304, the method 1300 may include generating, using the processing device, at least one processed in-situ forecast based on the post-processing.

Further, at 1306, the method 1300 may include transmitting, using the communication device, the at least one processed in-situ forecast to the at least one user device.

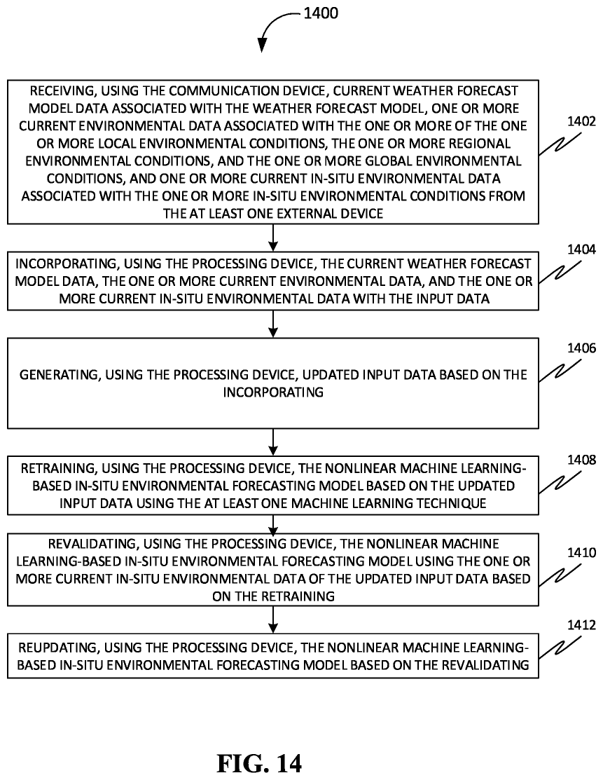

FIG. 14 is a flowchart of a method 1400 for reupdating the nonlinear machine learning-based in-situ environmental forecasting model for facilitating the forecasting the in-situ environmental conditions using the nonlinear artificial neural networks-based models, in accordance with some embodiments. Accordingly, at 1402, the method 1400 may include receiving, using the communication device, current weather forecast model data associated with the weather forecast model, one or more current environmental data associated with the one or more of the one or more local environmental conditions, the one or more regional environmental conditions, and the one or more global environmental conditions, and one or more current in-situ environmental data associated with the one or more in-situ environmental conditions from the at least one external device.

Further, at 1404, the method 1400 may include incorporating, using the processing device, the current weather forecast model data, the one or more current environmental data, and the one or more current in-situ environmental data with the input data.

Further, at 1406, the method 1400 may include generating, using the processing device, updated input data based on the incorporating.

Further, at 1408, the method 1400 may include retraining, using the processing device, the nonlinear machine learning-based in-situ environmental forecasting model based on the updated input data using the at least one machine learning technique.

Further, at 1410, the method 1400 may include revalidating, using the processing device, the nonlinear machine learning-based in-situ environmental forecasting model using the one or more current in-situ environmental data of the updated input data based on the retraining.

Further, at 1412, the method 1400 may include reupdating, using the processing device, the nonlinear machine learning-based in-situ environmental forecasting model based on the revalidating. Further, the generating of the updated nonlinear machine learning-based in-situ environmental forecasting model may be based on the reupdating.

Further, in an embodiment, the method 1400 may include generating, using the processing device, a data retrieve indication based on at least one operational criterion. Further, the data retrieve indication corresponds to an instance for retrieving the current weather forecast model data, the one or more current environmental data, and the one or more current in-situ environmental data from the at least one external device. Further, the at least one criterion specifies a period for the retrieving. Further, the at least one criterion describes a number of instances for the retrieving. Further, the at least one external device may include the current weather forecast model data, the one or more current environmental data, and the one or more current in-situ environmental data at the instance. Further, the receiving of the current weather forecast model data, the one or more current environmental data, and the one or more current in-situ environmental data may be based on the data retrieve indication.

Further, in an embodiment, the method 1400 may include preprocessing, using the processing device, the current weather forecast model data, the one or more current environmental data, and the one or more current in-situ environmental data. Further, the preprocessing may include performing at least one data cleaning action on the current weather forecast model data, the one or more current environmental data, and the one or more current in-situ environmental data. Further, the incorporating of the current weather forecast model data, the one or more current environmental data, and the one or more current in-situ environmental data with the input data may be based on the preprocessing.

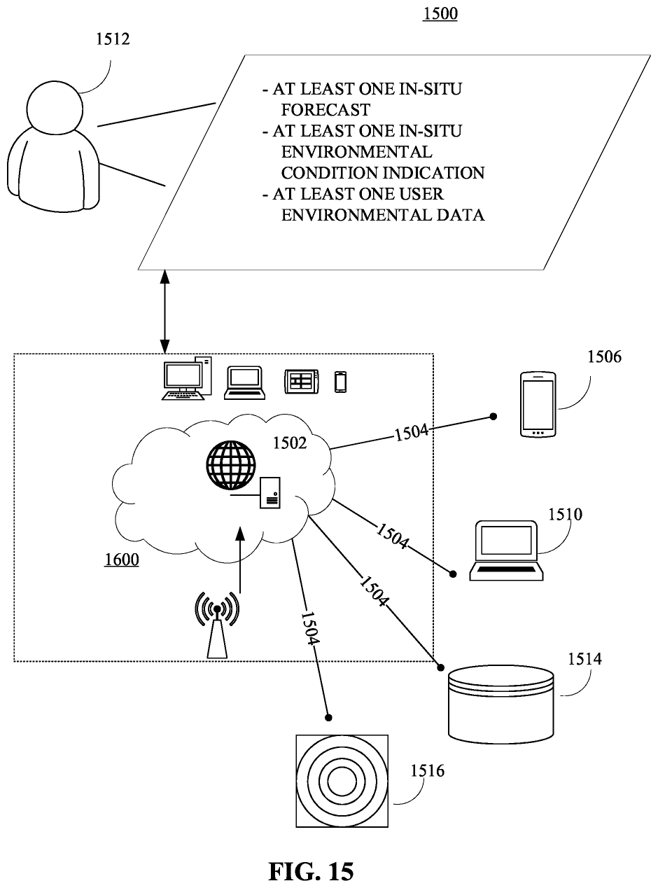

Referring now to figures, FIG. 15 is an illustration of an online platform 1500 consistent with various embodiments of the present disclosure. By way of non-limiting example, the online platform 1500 to facilitate forecasting of in-situ environmental conditions using nonlinear artificial neural networks-based models may be hosted on a centralized server 1502, such as, for example, a cloud computing service. The centralized server 1502 may communicate with other network entities, such as, for example, a mobile device 1506 (such as a smartphone, a laptop, a tablet computer etc.), other electronic devices 1510 (such as desktop computers, server computers etc.), databases 1514, and sensors 1516 over a communication network 1504, such as, but not limited to, the Internet. Further, users of the online platform 1500 may include relevant parties such as, but not limited to, end-users, administrators, service providers, service consumers and so on. Accordingly, in some instances, electronic devices operated by the one or more relevant parties may be in communication with the platform.

A user 1512, such as the one or more relevant parties, may access online platform 1500 through a web based software application or browser. The web based software application may be embodied as, for example, but not be limited to, a website, a web application, a desktop application, and a mobile application compatible with a computing device 1600.

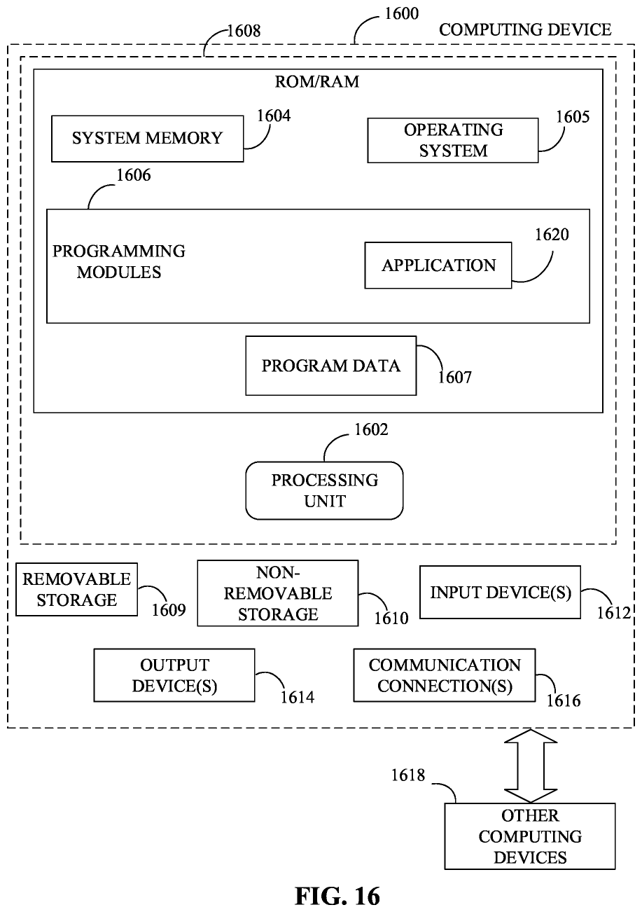

With reference to FIG. 16, a system consistent with an embodiment of the disclosure may include a computing device or cloud service, such as computing device 1600. In a basic configuration, computing device 1600 may include at least one processing unit 1602 and a system memory 1604. Depending on the configuration and type of computing device, system memory 1604 may comprise, but is not limited to, volatile (e.g. random-access memory (RAM)), non-volatile (e.g. read-only memory (ROM)), flash memory, or any combination. System memory 1604 may include operating system 1605, one or more programming modules 1606, and may include a program data 1607. Operating system 1605, for example, may be suitable for controlling computing device 1600's operation. In one embodiment, programming modules 1606 may include image-processing module, machine learning module. Furthermore, embodiments of the disclosure may be practiced in conjunction with a graphics library, other operating systems, or any other application program and is not limited to any particular application or system. This basic configuration is illustrated in FIG. 16 by those components within a dashed line 1608.

Computing device 1600 may have additional features or functionality. For example, computing device 1600 may also include additional data storage devices (removable and/or non-removable) such as, for example, magnetic disks, optical disks, or tape. Such additional storage is illustrated in FIG. 16 by a removable storage 1609 and a non-removable storage 1610. Computer storage media may include volatile and non-volatile, removable and non-removable media implemented in any method or technology for storage of information, such as computer-readable instructions, data structures, program modules, or other data. System memory 1604, removable storage 1609, and non-removable storage 1610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1600. Any such computer storage media may be part of device 1600. Computing device 1600 may also have input device(s) 1612 such as a keyboard, a mouse, a pen, a sound input device, a touch input device, a location sensor, a camera, a biometric sensor, etc. Output device(s) 1614 such as a display, speakers, a printer, etc. may also be included. The aforementioned devices are examples and others may be used.

Computing device 1600 may also contain a communication connection 1616 that may allow device 1600 to communicate with other computing devices 1618, such as over a network in a distributed computing environment, for example, an intranet or the Internet. Communication connection 1616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1604, including operating system 1605. While executing on processing unit 1602, programming modules 1606 (e.g., application 1620) may perform processes including, for example, one or more stages of methods, algorithms, systems, applications, servers, databases as described above. The aforementioned process is an example, and processing unit 1602 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

1. A method for facilitating forecasting of in-situ environmental conditions using nonlinear artificial neural networks-based models, the method comprising:
receiving, using a communication device, weather forecast model data associated with a weather forecast model, one or more environmental data associated with one or more of one or more local environmental conditions, one or more regional environmental conditions, and one or more global environmental conditions, and one or more in-situ environmental data associated with one or more in-situ environmental conditions from at least one external device;
analyzing, using a processing device, the weather forecast model data, the one or more environmental data, and the one or more in-situ environmental data;
generating, using the processing device, input data based on the analyzing;
training, using the processing device, a nonlinear machine learning-based in-situ environmental forecasting model based on the input data using at least one machine learning technique;
validating, using the processing device, the nonlinear machine learning-based in-situ environmental forecasting model using the one or more in-situ environmental data of the input data based on the training;
updating, using the processing device, the nonlinear machine learning-based in-situ environmental forecasting model based on the validating;
generating, using the processing device, an updated nonlinear machine learning-based in-situ environmental forecasting model based on the updating;
generating, using the processing device, at least one in-situ forecast for at least one in-situ environmental condition based on the updated nonlinear machine learning-based in-situ environmental forecasting model;
transmitting, using the communication device, the at least one in-situ forecast to at least one user device; and
storing, using a storage device, the nonlinear machine learning-based in-situ environmental forecasting model and the updated nonlinear machine learning-based in-situ environmental forecasting model.

2. The method of claim 1, wherein the at least one machine learning technique comprises a nonlinear regression, wherein the nonlinear regression comprises at least one of a feedforward neural network, a support vector regression, and a quantile regression.

3. The method of claim 1 further comprising:
receiving, using the communication device, at least one in-situ environmental condition indication from the at least one user device; and
identifying, using the processing device, the at least one in-situ environmental condition associated with the at least one in-situ environmental condition indication, wherein the generating of the at least one in-situ forecast for the at least one in-situ environmental condition is further based on the identifying.

4. The method of claim 1, wherein the at least one external device comprises one or more in-situ environmental sensors, wherein the one or more in-situ environmental sensors are disposed in one or more locations at one or more elevations, wherein the one or more in-situ environmental sensors are configured for generating the one or more in-situ environmental data associated with the one or more in-situ environmental conditions at the one or more elevations of the one or more locations, wherein the at least one in-situ forecast for the at least one in-situ environmental condition is associated with the one or more locations.

5. The method of claim 1 further comprising receiving, using the communication device, at least one user environmental data associated with one or more of the one or more local environmental conditions, the one or more regional environmental conditions, the one or more global environmental conditions, and the one or more in-situ environmental conditions from the at least one user device, wherein the generating of the input data is further based on the at least one user environmental data.

6. The method of claim 1, wherein the analyzing of the weather forecast model data, the one or more environmental data, and the one or more in-situ environmental data comprises preprocessing the weather forecast model data, the one or more environmental data, and the one or more in-situ environmental data, wherein the preprocessing comprises performing at least one data cleaning action on the weather forecast model data, the one or more environmental data, and the one or more in-situ environmental data, wherein the generating of the input data is further based on the preprocessing.

7. The method of claim 1 further comprising:
post-processing, using the processing device, the at least one in-situ forecast based on the generating of the at least one in-situ forecast, wherein the post-processing comprising performing at least one data quality control operation on the at least one in-situ forecast;
generating, using the processing device, at least one processed in-situ forecast based on the post-processing; and
transmitting, using the communication device, the at least one processed in-situ forecast to the at least one user device.

8. The method of claim 1 further comprising:
receiving, using the communication device, current weather forecast model data associated with the weather forecast model, one or more current environmental data associated with the one or more of the one or more local environmental conditions, the one or more regional environmental conditions, and the one or more global environmental conditions, and one or more current in-situ environmental data associated with the one or more in-situ environmental conditions from the at least one external device;
incorporating, using the processing device, the current weather forecast model data, the one or more current environmental data, and the one or more current in-situ environmental data with the input data;
generating, using the processing device, updated input data based on the incorporating;
retraining, using the processing device, the nonlinear machine learning-based in-situ environmental forecasting model based on the updated input data using the at least one machine learning technique;
revalidating, using the processing device, the nonlinear machine learning-based in-situ environmental forecasting model using the one or more current in-situ environmental data of the updated input data based on the retraining; and
reupdating, using the processing device, the nonlinear machine learning-based in-situ environmental forecasting model based on the revalidating, wherein the generating of the updated nonlinear machine learning-based in-situ environmental forecasting model is further based on the reupdating.

9. The method of claim 8 further comprising generating, using the processing device, a data retrieve indication based on at least one operational criterion, wherein the data retrieve indication corresponds to an instance for retrieving the current weather forecast model data, the one or more current environmental data, and the one or more current in-situ environmental data from the at least one external device, wherein the at least one external device comprises the current weather forecast model data, the one or more current environmental data, and the one or more current in-situ environmental data at the instance, wherein the receiving of the current weather forecast model data, the one or more current environmental data, and the one or more current in-situ environmental data is based on the data retrieve indication.

10. The method of claim 8 further comprising preprocessing, using the processing device, the current weather forecast model data, the one or more current environmental data, and the one or more current in-situ environmental data, wherein the preprocessing comprises performing at least one data cleaning action on the current weather forecast model data, the one or more current environmental data, and the one or more current in-situ environmental data, wherein the incorporating of the current weather forecast model data, the one or more current environmental data, and the one or more current in-situ environmental data with the input data is further based on the preprocessing.

11. A system for facilitating forecasting of in-situ environmental conditions using nonlinear artificial neural networks-based models, the system comprising:
a communication device configured for:
receiving weather forecast model data associated with a weather forecast model, one or more environmental data associated with one or more of one or more local environmental conditions, one or more regional environmental conditions, and one or more global environmental conditions, and one or more in-situ environmental data associated with one or more in-situ environmental conditions from at least one external device; and
transmitting at least one in-situ forecast to at least one user device;
a processing device communicatively coupled with the communication device, wherein the processing device is configured for:
analyzing the weather forecast model data, the one or more environmental data, and the one or more in-situ environmental data;
generating input data based on the analyzing;
training a nonlinear machine learning-based in-situ environmental forecasting model based on the input data using at least one machine learning technique;
validating the nonlinear machine learning-based in-situ environmental forecasting model using the one or more in-situ environmental data of the input data based on the training;
updating the nonlinear machine learning-based in-situ environmental forecasting model based on the validating;
generating an updated nonlinear machine learning-based in-situ environmental forecasting model based on the updating; and
generating the at least one in-situ forecast for at least one in-situ environmental condition based on the updated nonlinear machine learning-based in-situ environmental forecasting model; and
a storage device communicatively coupled with the processing device, wherein the storage device is configured for storing the nonlinear machine learning-based in-situ environmental forecasting model and the updated nonlinear machine learning-based in-situ environmental forecasting model.

12. The system of claim 11, wherein the at least one machine learning technique comprises a nonlinear regression, wherein the nonlinear regression comprises at least one of a feedforward neural network, a support vector regression, and a quantile regression.

13. The system of claim 11, wherein the communication device is further configured for receiving at least one in-situ environmental condition indication from the at least one user device, wherein the processing device is further configured for identifying the at least one in-situ environmental condition associated with the at least one in-situ environmental condition indication, wherein the generating of the at least one in-situ forecast for the at least one in-situ environmental condition is further based on the identifying.

14. The system of claim 11, wherein the at least one external device comprises one or more in-situ environmental sensors, wherein the one or more in-situ environmental sensors are disposed in one or more locations at one or more elevations, wherein the one or more in-situ environmental sensors are configured for generating the one or more in-situ environmental data associated with the one or more in-situ environmental conditions at the one or more elevations of the one or more locations, wherein the at least one in-situ forecast for the at least one in-situ environmental condition is associated with the one or more locations.

15. The system of claim 11, wherein the communication device is further configured for receiving at least one user environmental data associated with one or more of the one or more local environmental conditions, the one or more regional environmental conditions, the one or more global environmental conditions, and the one or more in-situ environmental conditions from the at least one user device, wherein the generating of the input data is further based on the at least one user environmental data.

16. The system of claim 11, wherein the analyzing of the weather forecast model data, the one or more environmental data, and the one or more in-situ environmental data comprises preprocessing the weather forecast model data, the one or more environmental data, and the one or more in-situ environmental data, wherein the preprocessing comprises performing at least one data cleaning action on the weather forecast model data, the one or more environmental data, and the one or more in-situ environmental data, wherein the generating of the input data is further based on the preprocessing.

17. The system of claim 11, wherein the processing device is further configured for:
post-processing the at least one in-situ forecast based on the generating of the at least one in-situ forecast, wherein the post-processing comprising performing at least one data quality control operation on the at least one in-situ forecast; and
generating at least one processed in-situ forecast based on the post-processing, wherein the communication device is further configured for transmitting the at least one processed in-situ forecast to the at least one user device.

18. The system of claim 11, wherein the communication device is further configured for receiving current weather forecast model data associated with the weather forecast model, one or more current environmental data associated with the one or more of the one or more local environmental conditions, the one or more regional environmental conditions, and the one or more global environmental conditions, and one or more current in-situ environmental data associated with the one or more in-situ environmental conditions from the at least one external device, wherein the processing device is further configured for:
incorporating the current weather forecast model data, the one or more current environmental data, and the one or more current in-situ environmental data with the input data;
generating updated input data based on the incorporating,
retraining the nonlinear machine learning-based in-situ environmental forecasting model based on the updated input data using the at least one machine learning technique;
revalidating the nonlinear machine learning-based in-situ environmental forecasting model using the one or more current in-situ environmental data of the updated input data based on the retraining; and
reupdating the nonlinear machine learning-based in-situ environmental forecasting model based on the revalidating, wherein the generating of the updated nonlinear machine learning-based in-situ environmental forecasting model is further based on the reupdating.

19. The system of claim 18, wherein the processing device is further configured for generating a data retrieve indication based on at least one operational criterion, wherein the data retrieve indication corresponds to an instance for retrieving the current weather forecast model data, the one or more current environmental data, and the one or more current in-situ environmental data from the at least one external device, wherein the at least one external device comprises the current weather forecast model data, the one or more current environmental data, and the one or more current in-situ environmental data at the instance, wherein the receiving of the current weather forecast model data, the one or more current environmental data, and the one or more current in-situ environmental data is based on the data retrieve indication.

20. A method for facilitating forecasting of in-situ environmental conditions using nonlinear artificial neural networks-based models, the method comprising:
receiving, using a communication device, weather forecast model data associated with a weather forecast model and one or more in-situ environmental data associated with one or more in-situ environmental conditions from at least one external device;
analyzing, using a processing device, the weather forecast model data, the one or more environmental data, and the one or more in-situ environmental data;
generating, using the processing device, input data based on the analyzing;
training, using the processing device, a nonlinear machine learning-based in-situ environmental forecasting model based on the input data using at least one machine learning technique;
validating, using the processing device, the nonlinear machine learning-based in-situ environmental forecasting model using the one or more in-situ environmental data of the input data based on the training;
updating, using the processing device, the nonlinear machine learning-based in-situ environmental forecasting model based on the validating;
generating, using the processing device, an updated nonlinear machine learning-based in-situ environmental forecasting model based on the updating;
generating, using the processing device, at least one in-situ forecast for at least one in-situ environmental condition based on the updated nonlinear machine learning-based in-situ environmental forecasting model;
transmitting, using the communication device, the at least one in-situ forecast to at least one user device; and
storing, using a storage device, the nonlinear machine learning-based in-situ environmental forecasting model and the updated nonlinear machine learning-based in-situ environmental forecasting model.
